(19) United States
(12) Patent Application Publication
(10) Pub. No.: US 2015/0117244 A1
(43) Pub. Date: Apr. 30, 2015

(54) METHODS TO VISUALIZE TIME-ALIGNED DATA FLOW BETWEEN NODES IN A COMMUNICATION NETWORK

(71) Applicant: Fluke Corporation, Everett, WA (US)

(72) Inventor: Michael A. Williamson, Colorado Springs, CO (US)

(73) Assignee: FLUKE CORPORATION, Everett, WA (US)

(21) Appl. No.: 14/525,812

(22) Filed: Oct. 28, 2014

Related U.S. Application Data
(60) Provisional application No. 61/897,631, filed on Oct. 30, 2013.

(51) Int. Cl. H04L 12/26

(52) U.S. Cl. CPC H04L 43/045; H04L 43/067; H04L 43/18
USPC 370/252

(57) ABSTRACT

Disclosed herein are techniques for improved network management, including improved visualization of network events. According to one embodiment, a network monitoring node receives performance data corresponding to at least one network parameter for a network path between a source node and a destination node, and receives a user-specified time period. The network monitoring node further determines a time associated with the performance data, and aligns the performance data according to the associated time and the at least one time index for each node in the network path. The network monitoring node simultaneously presents the performance data for each network node in the network path aligned according to the associated time and the at least one time index for the user-specified time period.

### CROSS-REFERENCE TO RELATED APPLICATIONS

The present application is claiming priority of U.S. Provisional Patent Application Ser. No. 61/897,631, filed on Oct. 30, 2013, the content of which is herein incorporated by reference.

### BACKGROUND

1. Field of the Invention

The present disclosure relates to network monitoring, and more particularly to improved techniques to display network performance data to a user.

2. Description of the Related Art

Communication networks have become commonplace in the modern business world—private internal servers to enterprise architectures that support cloud based solutions. Increasingly, these communication networks are becoming more complex as modern business continues to shift various services into the digital world (e.g., Voice-over-IP) while also demanding the same (or even better) overall performance.

Typically, in an effort to improve network performance network events, such as network performance events, are continuously monitored by, for example, network infrastructure (e.g., servers, routers, switches, etc.) and/or independent network monitoring devices. However, due to an ever increasing network complexity, some performance issues can prove difficult to detect, identify and troubleshoot. For example, certain network events can be self-corrected by network nodes (e.g., data is re-routed) before a network operator is made aware of an underlying issue. Other network events may simply prove too difficult to parse due to the amount of collected data.

Accordingly, there remains a need for improved network monitoring and particularly, for improved visualization techniques that efficiently identify and display network performance data to a user (e.g., a system administer, a network operator, and the like).

### SUMMARY

Network trouble analysis is facilitated and/or enhanced by the improved display techniques disclosed herein. In particular, these techniques present or display a visual representation of a network path amongst various network nodes aligned according to a single time index. As discussed in greater detail below, a network monitoring node determine performance indicators for each network node in a particular path, and aligns the performance data according to the time index such that performance data corresponding to a network event is simultaneously shown across each network node.

According to one embodiment of this disclosure, a network monitoring device or node receives performance data corresponding to at least one network parameter for a network path between a source node and a destination node, and also receives a user-specified time period. The network monitoring device determines a time associated with the performance data, and aligns the performance data according to the associated time and the at least one time index for each node in the network path. The network monitoring device simultaneously presents the performance data for each network node in the network path aligned according to the associated time and the at least one time index for the user-specified time period.

In certain embodiments, the performance data is further assigned to a transmitting side or a receiving side for a corresponding node. In these embodiments, the network monitoring node further simultaneously displays the performance data for each transmitting side and each receiving side for the corresponding node aligned according to the associated time and the at least one time index for the user-specified time period.

In other embodiments, a network user may wish to view more granular or detailed performance data, or alternatively, the user may wish to view high-level performance data. In either instance, the network monitoring node receives a request for the corresponding level of detail and derives the appropriate level of data—e.g., high level performance data or detailed performance data—from the performance data. As with the above embodiments, the network monitoring node further determines a time associated with the derived data, aligns the derived data according to the associated time and the at least one time index for each node in the network path, and simultaneously presents the derived data for each network node in the network path aligned according to the associated time and the at least one time index for the user-specified time period. With respect to deriving high-level performance data, the network monitoring node can, for example, average portions of the performance data assigned to the transmitting side and the receiving side for each network node in the network path to yield high-level performance data.

In some embodiments, the network monitoring node determines one or more Key Performance Indicators (KPIs) from the performance data. The determined KPIs, like the performance data discussed above, are further associated with a time, aligned according to the time index for each network node in the network path, and simultaneously presented according to the associated time and the at least one time index for the user-specified time period. KPI(s) can include, for example, a total number of bytes flowing through an interface for each node in the network path, a CPU load for each node in the network path, a delay time for each node in the network path, and a memory utilization for each node in the network path.

These and other features of the systems, devices, and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 illustrates an example communication network in accordance with an illustrated embodiment;

FIG. 2 illustrates internal and external components of a network monitoring device/node in accordance with an illustrative embodiment of the present disclosure:

FIG. 3 is an exemplary visualization of data flow amongst interconnected nodes in accordance with illustrative embodiments of the present disclosure;

FIG. 4 is an exemplary visualization of data flow amongst interconnected nodes showing in FIG. 3 and including additional data flow for respective nodes in accordance with an embodiment of the present disclosure;

FIG. 5 is an exemplary summary visualization of data flow shown in FIGS. 3-4 in accordance with the present disclosure;

FIG. 6 is a flow diagram of operational steps of the data analysis engine of FIG. 1 in accordance with an illustrative embodiment of the present disclosure; and

FIG. 7 illustrates an example simplified procedure for visualizing performance data for nodes in a network path, particularly from the perspective of a network monitoring node.

A component or a feature that is common to more than one drawing is indicated with the same reference number in each of the drawings.

### DETAILED DESCRIPTION OF CERTAIN EMBODIMENTS

In a communication network, traffic or data flows between nodes or network devices along one or more data paths (e.g., from a source node to a destination node including nodes there-between). As discussed above, isolating traffic or network data relating to network performance issues for a conventional data path is difficult at best due to an inherent underlying network complexity (e.g., numerous paths, numerous nodes, etc.). This disclosure provides improved techniques for network monitoring to facilitate identifying and troubleshooting performance based network events. For example, these improved network monitoring techniques provide improved visual representations of network paths amongst various network nodes. Importantly, such visual representations, as discussed in greater detail below, include performance indicators for each network node for a particular path aligned or indexed according to a time index (e.g., such that any event on the path is shown across each network node at the same time).

The present disclosure is now described more fully with reference to the accompanying drawings. The present disclosure is not limited in any way to the illustrated embodiments as the illustrated embodiments described below are merely exemplary of the disclosure, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present disclosure. Furthermore, the terms and phrases used herein are not intended to be limiting but rather to provide an understandable description of the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, exemplary methods and materials are now described. All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided may differ from the actual publication dates which may need to be independently confirmed.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the embodiments of this disclosure as discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the disclosure based on the above-described embodiments. Accordingly, the disclosure is not to be limited by what has been particularly shown and described, except as indicated by the appended claims.

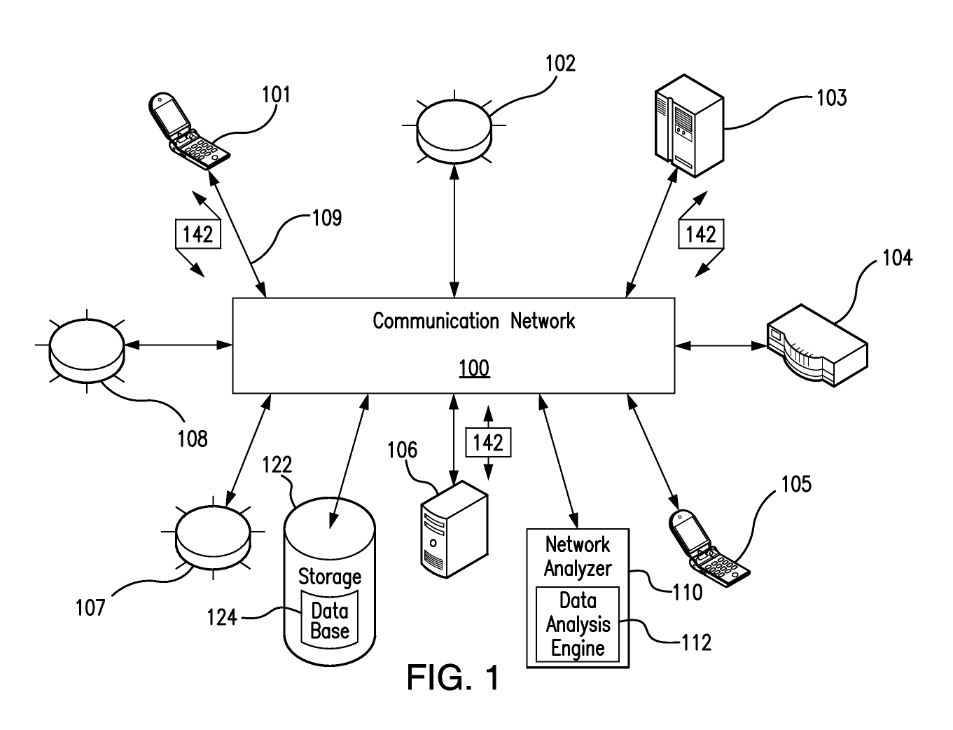

Turning now descriptively to the drawings, in which similar reference characters denote similar elements throughout the several views, FIG. 1 depicts an exemplary communication network 100 in which bellow illustrated embodiments may be implemented.

It is to be understood a communication network 100 is a geographically distributed collection of nodes interconnected by communication links or interfaces and segments for transporting data between end nodes, such as smart phones, pads, personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

The exemplary communication network 100 of FIG. 1 illustratively comprises nodes/devices 101-108 (e.g., sensors 102, client computing devices 103, smart phone devices 101, 105, servers 106, routers 107, switches 108 and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

Network monitoring is an important operational scheme for network operators. According to an embodiment of the present disclosure, a network monitoring device 110 is also communicatively connected to the network 100. The network monitoring device 110 may include a user interface (not shown in FIG. 1) that enables a user to interact with the network monitoring device 110, to operate the network monitoring device 110, and to obtain data therefrom, whether at the location of installation or remotely. Alternatively, the client computing device 103 may include the user interface communicatively coupled to the network monitoring device 110.

According to an embodiment of the present disclosure, network monitoring device 110 may comprise, or otherwise may cooperate with a data analysis engine 112. Data analysis engine 112 may comprise program instructions stored on one or more computer-readable storage devices, which may include internal storage on the network monitoring device 110. Data analysis engine 112 may be configured to monitor traffic on the communication network 100, as well as to perform various testing and measurement operations, to conduct analysis of collected data, to present data to a user, and the like. In an embodiment of the present disclosure, data analysis engine 112 may be, for example, a computer program or program component capable of providing certain information about end user's response time, as described in more detail below. Data gathered, generated, and maintained for use by the data analysis engine 112 may be kept in the internal storage of the network monitoring device 110 or in one or more databases 124 of a storage unit 122.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

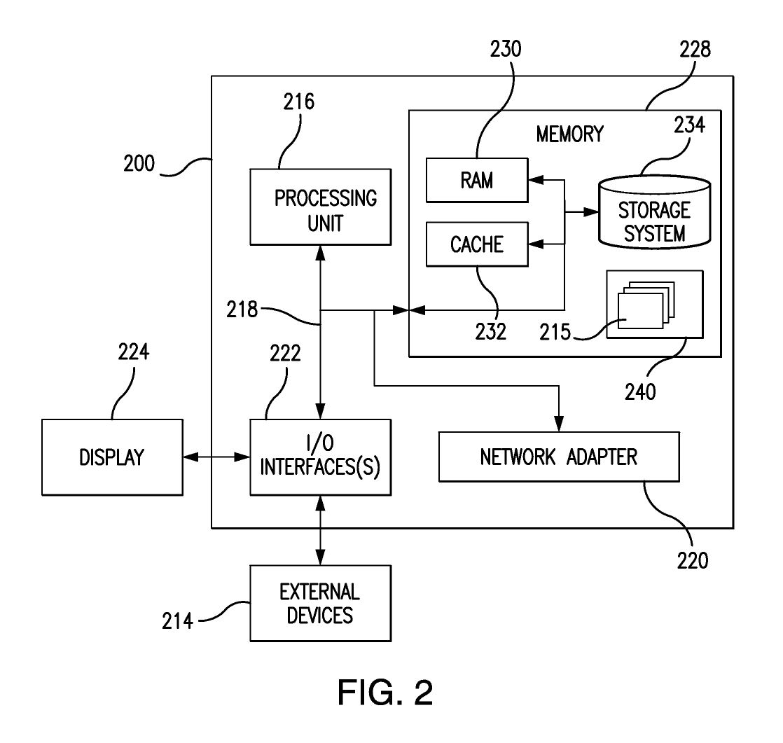

FIG. 2 is a schematic block diagram of an example network monitoring device 110 that may be used (or components thereof) with one or more embodiments described herein. Network monitoring device 110 is only one example of a suitable system and is not intended to suggest any limitation as to the scope of use or functionality of embodiments of the disclosure described herein. Regardless, network monitoring device 110 is capable of being implemented and/or performing any of the functionality set forth herein.

Network monitoring device 110 is operational with numerous other general purpose or special purpose computing system environments or configurations. Examples of well-known computing systems, environments, and/or configurations that may be suitable for use with network monitoring device 110 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed data processing environments that include any of the above systems or devices, and the like.

Network monitoring device 110 may be described in the general context of computer system-executable instructions, such as program modules, being executed by a computer system. Generally, program modules may include routines, programs, objects, components, logic, data structures, and so on that perform particular tasks or implement particular abstract data types. Network monitoring device 110 may be practiced in distributed data processing environments where tasks are performed by remote processing devices that are linked through the communication network 100. In a distributed data processing environment, program modules may be located in both local and remote computer system storage media including memory storage devices.

Network monitoring device 110 is shown in FIG. 2 in the form of a general-purpose computing device. The components of device 110 may include, but are not limited to, one or more processors or processing units 216, a system memory 228, and a bus 218 that couples various system components including system memory 228 to processor 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Network monitoring device 110 typically includes a variety of computer system readable media. Such media may be any available media that is accessible by device 110, and it includes both volatile and non-volatile media, removable and non-removable media.

System memory 228 can include computer system readable media in the form of volatile memory, such as random access memory (RAM) 230 and/or cache memory 232. Network monitoring device 110 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the disclosure.

Program/utility 240, having a set (at least one) of program modules 215, such as data analysis engine module 112 described below, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of embodiments of the disclosure as described herein.

Network monitoring device 110 may also communicate with one or more external devices 214 such as a keyboard, a pointing device, a display 224, etc.; one or more devices that enable a user to interact with network monitoring device 110; and/or any devices (e.g., network card, modem, etc.) that enable network monitoring device 110 to communicate with one or more other computing devices. Such communication can occur via Input/Output (I/O) interfaces 222. Still yet, device 110 can communicate with one or more networks such as a local area network (LAN), a general wide area network (WAN), and/or a public network (e.g., the Internet) via network adapter 220. As depicted, network adapter 220 communicates with the other components of network monitoring device 110 via bus 218. It should be understood that although not shown, other hardware and/or software components could be used in conjunction with device 110. Examples, include, but are not limited to: microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which embodiments of the below described present disclosure may be implemented. FIGS. 1 and 2 are not intended to suggest any limitation as to the structure, scope of use, or functionality of an embodiment of the present disclosure. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

As noted above, traditional network trouble shooting can involve numerous steps to identify and isolate problematic network nodes. For example, performance parameters, routing problems, congestion, travel time, and the like, are an aggregation of events spread across multiple devices or network nodes. Accordingly, monitoring and isolating problematic paths and problematic points (e.g., nodes) within the communication network proves tedious at best. The present disclosure provides a visual tool to simplify, identify, and isolate data path flow amongst various connected nodes and displaying such data flow (including performance parameters) in a time-aligned fashion. Put differently, this disclosure provides a visual representation for data flow across network nodes indexed according to time to facilitate network troubleshooting and analysis. Such visualization can include displaying one or more performance parameters of respective network nodes on both a receiving side and a transmitting side. In this fashion, the visualization and analysis techniques described herein are generally useful for the purpose of facilitating network analysis (e.g., troubleshooting enterprise application problems and optimizing computer network 100 performance). The term “visualization” here refers to the transformation of numerical data into graphical objects generated by computer software and viewed by the software user. Advantageously, various embodiments of the present disclosure utilize visualization techniques to present complex data in a concise and comprehensible way.

Referring again to FIG. 1, network monitoring device 110 monitors network data or network traffic in the communication network 100 by monitoring, for example, network tap points, directly querying various network nodes/devices, and the like, as is appreciated by those skilled in the art. Network monitoring device 110 collects and aggregates network performance data regarding network performance (e.g., key performance indicators (KPIs), and the like). In certain embodiments, network monitoring device 110 can further inject or introduce certain data packets into communication network 100 and monitor the propagation of the injected or introduced data packets to determine network performance data. Additionally, network monitoring device 110 determines network paths for network data between nodes (e.g., between a source node and a destination node), as is appreciated by those skilled in the art. For example, network monitoring device 110 can perform various trace route protocols in determining the network paths. Moreover, while the performance data discussed herein relates to network monitoring, such performance data is not limited to such. Instead, as is appreciated by those skilled in the art, these performance data can encompass a broader concept for any flow of data within a nodal system, including, for example oil through a pipeline, power in a power grid, traffic on highways, and the like.

Operatively, network monitoring device 110 receives the network data, including performance data, and determines a time associated therewith. For example, the network monitoring device 110 can parse the received data packets to determine a time associated with the data packet (e.g., a time received at a corresponding network node, etc.). Network monitoring device 110 compiles the network data for each node in a network path and indexes the performance data according to the associated time. Put differently, network monitoring device 110 re-orders or indexes the received network data according the associated time for each data packet for the corresponding node. In this fashion, network monitoring device 110 obviates the need to receive data packets in a particular order.

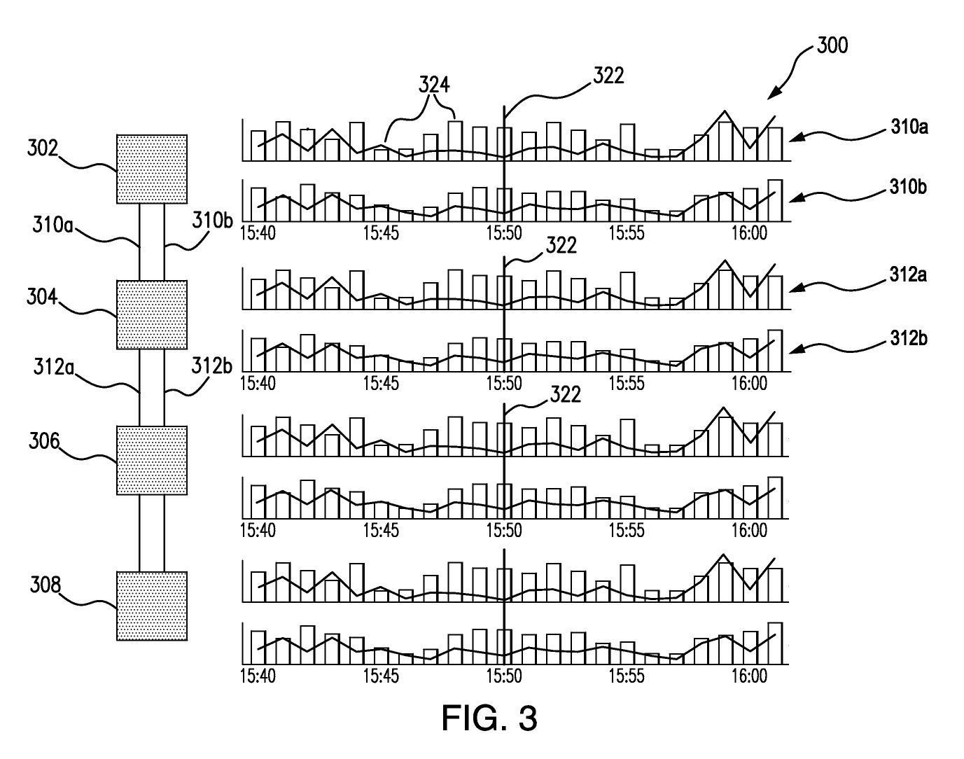

Network monitoring device 110 is also configured to simultaneously present the organized or indexed performance data for each network node in the network path according to user-specified time intervals. For example, in preferred embodiments, network monitoring device 110 provides the organized or indexed performance data to a display device. Examples of this simultaneous presentation are shown in FIGS. 3-5, discussed below.

Referring now to FIG. 3, there is shown an exemplary visualization 300 illustrating data flow amongst network devices or nodes and a corresponding graph aligned according to a time axis or time index showing performance indicators 324 (e.g., bars in the respective bar graph). Performance indicators 324 can include, for example, service performance indicators, network congestion indicators, bandwidth indicators, connection maintenance indicators, quality of experience (QoE) indicators, quality of service (QoS) indicators, network availability indicators, or other indicators germaine to data flow in a nodal system (e.g., oil in a pipeline, traffic on roadways, electricity in power lines, etc.), and the like, as is appreciated by those skilled in the art.

As shown, performance indicators 324 are displayed as graphical realizations of data in a network path and are indexed according to a time alignment or time index 322 (e.g., centered at or indexed to 15:50) for each node. Further, as shown in FIG. 3, each of the network nodes (e.g., nodes 302, 304, 306 and 308) is interconnected via respective communication links or interfaces (e.g., 310a/310b, 312a/310b, etc.).

Notably, each communication link is shown as a paired coupling with an “a” link and a “b” link. In this example, an “a” link is a transmit link to a respective node while a “b” link is a receive link for the respective node. Similarly, the visual representations likewise follow the “a” link and “b” link and are shown as two separate graphs alongside each respective node. It is further appreciated that the “a” link and “b” link are shown as two physically separate links for purposes of illustration, not limitation—network nodes can use a single link to transmit and receive messages and/or use any number links for the same.

As discussed above, a network node (here, network monitoring device 110) receives performance data corresponding to network parameters for a network path between a source node—i.e., node 302—and a destination node—i.e., node 308. The network monitoring device 110 also determines a time associated with the received performance data (e.g., a time corresponding to each data packet of the performance data). The network monitoring device further receives a user-specified time period (e.g., 15:40-16:00), and a time index (e.g., 15:50). The network monitoring device aligns or indexes the received performance data according to its associated time and the time index, and simultaneously presents or causes the display of the same. That is, the performance data for each network node in the network path is displayed according to its associated time and the time index for the user-specified time period. As shown in FIG. 3, the performance data for each network node 302, 304, 306, and 308 is displayed in a corresponding graph (e.g., two graphs corresponding to a transmit link and a receive link, respectively). Specifically, each graph for the network nodes 302-308 are centered at an axis according to time index 15:50 for the user-specified time period. In this fashion, a user such as a network operator, system administrator, etc., can quickly scan the visual representation of performance data for each network node in the network path, identify any anomalies, compare differences in performance data, and generally troubleshoot and isolate network performance problems for the network path.

Notably, the network monitoring device 110 can also assign portions of the performance data to at least one of a transmitting side and a receiving side for the corresponding node in the network path and simultaneously presents the performance data according to each transmit/receive side, shown in visualization 300.

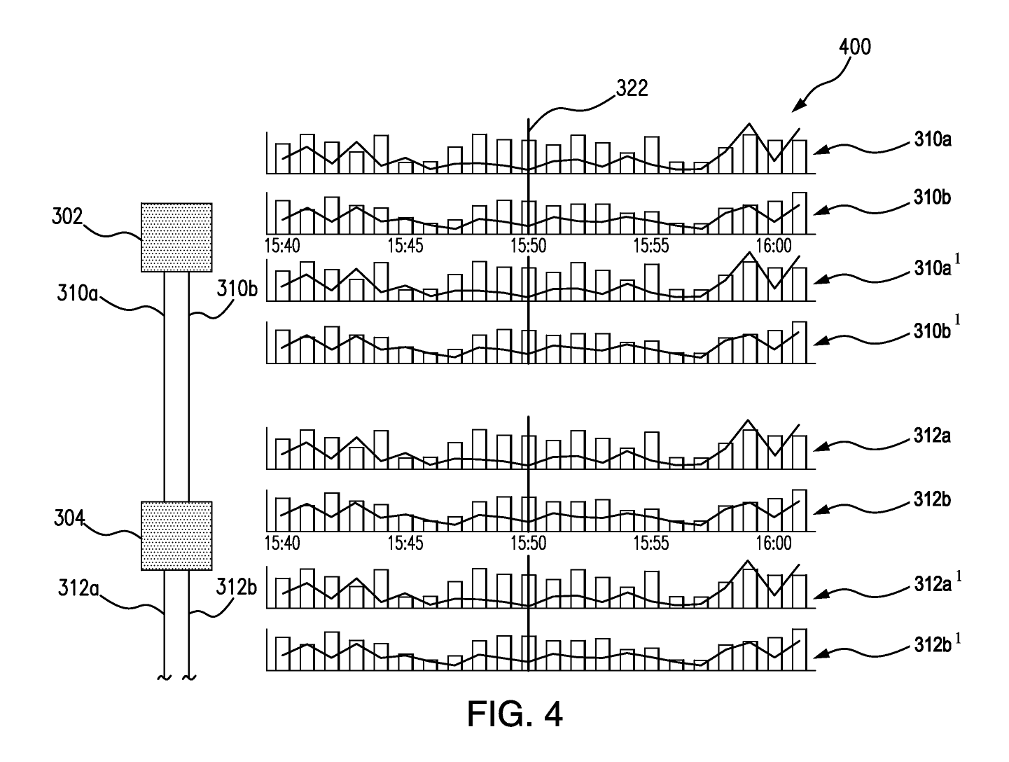

FIG. 4 illustrates a visualization 400 of data flow amongst the interconnected nodes shown in FIG. 3, further showing additional performance data for each transmit and receive link for each respective node. As discussed above, the performance data can include any number of key performance indicators (KPIs) (e.g., a total number of bytes flowing through an interface, a CPU load, a delay time, a memory utilization, etc.). The network monitoring device 110 can determine, and simultaneously display, multiple KPIs at the same time, and for each link of a respective network node. As shown, 310a¹/310b¹ and 312a¹/312b¹ illustrate at least one additional parameter for visualization. Importantly, each of the additional parameters is also aligned according to time alignment 322.

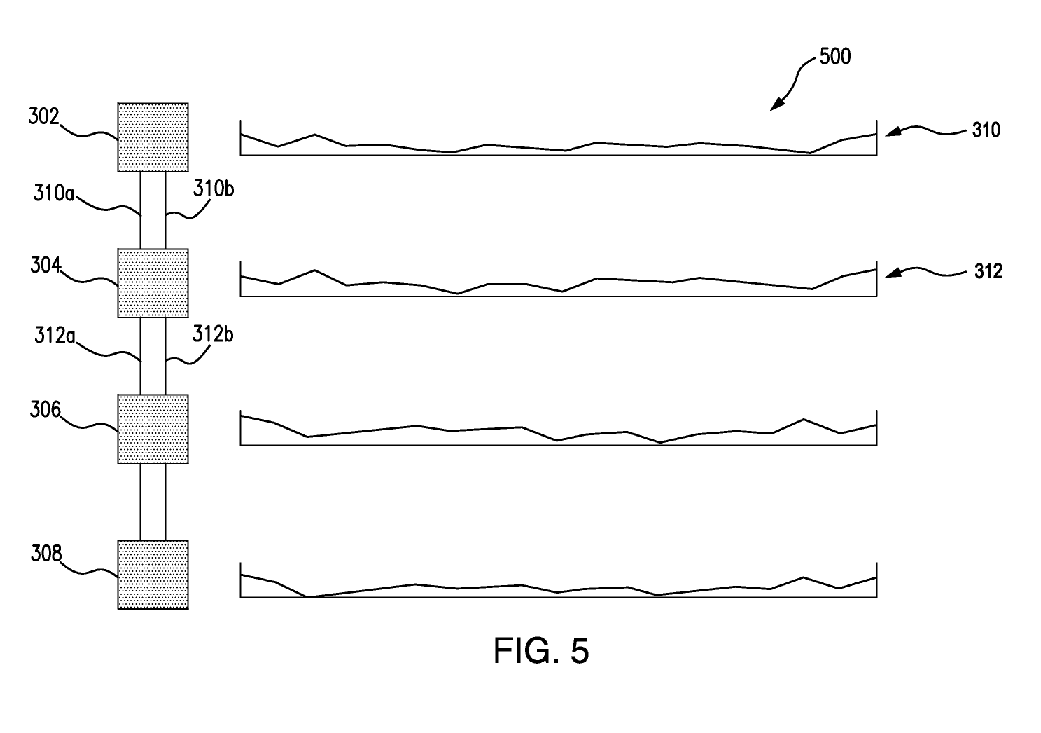

FIG. 5 illustrates an exemplary summary or condensed visualization 500 of data flow shown in FIGS. 3-4, discussed above. As shown in FIG. 5, each set of data flow (e.g., 310a/310b, 310a¹/310b¹, 312a/312b, 312a¹/312b¹, etc.) can be condensed such that a user can analyze and monitor an entire data flow for a respective node (both transmitting side and receiving side) and identify broad network events of interest. The user has options to drill down or obtain further detail for specific events of interest. In this fashion, FIG. 5 presents a high-level analysis of data flow for network nodes and allows a user to select particular events to obtain further detail (shown in FIGS. 3-4). As shown, the performance data for each network node, including the data associated with the transmitting link and the receiving link, is averaged or otherwise aggregated into a single graph—i.e., graph 310 for node 302, averaging performance data for transmitting link 310a and receiving link 310b.

Collectively referring to FIGS. 3-5, a user can request an appropriate level of detail, as is appreciated by those skilled in the art. A user can request more granular detail or higher-level details for the displayed performance data (e.g., zoom in or zoom out). Such requests cause the network monitoring node to derive the appropriate detail from the performance data—e.g., detailed performance data or high-level performance data—and simultaneously present such derived data for each node in the network path. Additionally, as discussed above, the more detailed performance data can further be assigned to ingress or egress sides (e.g., transmit or receive, respectively) for nodes in the network path.

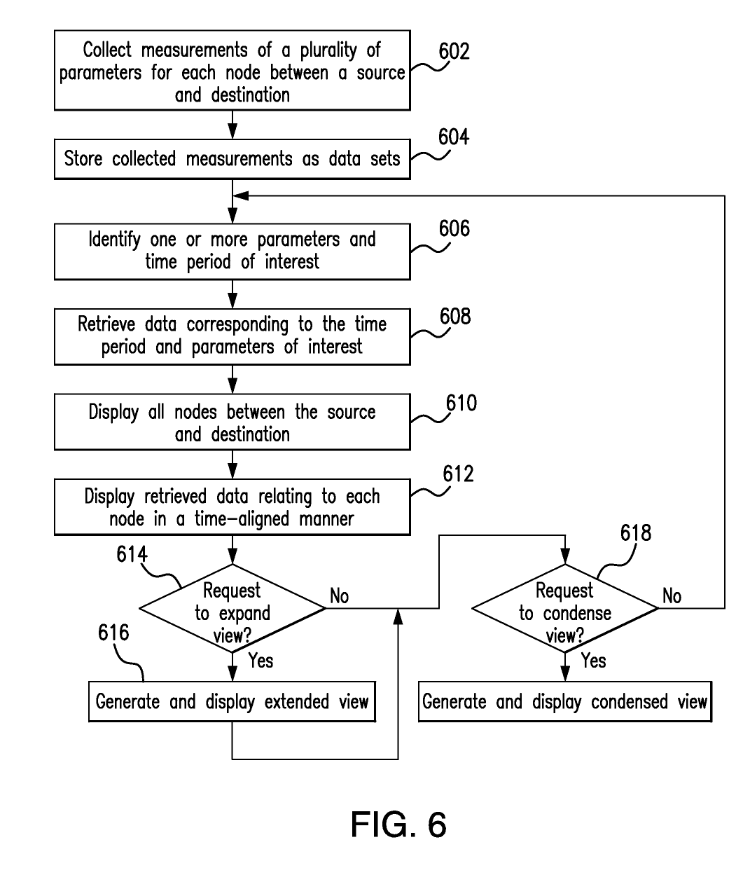

FIG. 6 is a flow diagram of operational steps of the data analysis engine 112 of FIG. 1 in accordance with an illustrative embodiment of the present disclosure. At 602, data analysis engine 112 collects measurements of a plurality performance related parameters (e.g., client data transfer time, server response time, server data transfer time, etc.) for each node between a source and a destination (e.g., source node 302 to destination node 308 shown in FIGS. 3-5). In an embodiment of the present disclosure, data analysis engine 112 determines the collection time for each data point.

At 604, data analysis engine 112 preferably stores collected information as measurement data sets. In an embodiment of the present disclosure, data analysis engine 112 stores gathered data in one or more databases 124 of the storage unit 122. Data analysis engine 112 preferably associates each data set with a particular performance related parameter.

At 606, data analysis engine identifies one or more parameters and a time period of interest (e.g., in response to a user request to present information of interest (i.e., end user response time) for a selected time interval, etc.). Upon retrieving the requested data at 608, data analysis engine 112 preferably displays all nodes between the source and destination and at 612, presents a visualization of the retrieved data relating to each node in a time-aligned manner.

As discussed above, a user may be presented with a high-level view of the performance parameters for each node (ref. FIG. 5), which high-level view can be further expanded upon (ref. FIGS. 3-4)—generally shown in steps 614-618.

The flowchart and block diagrams in FIG. 6 illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

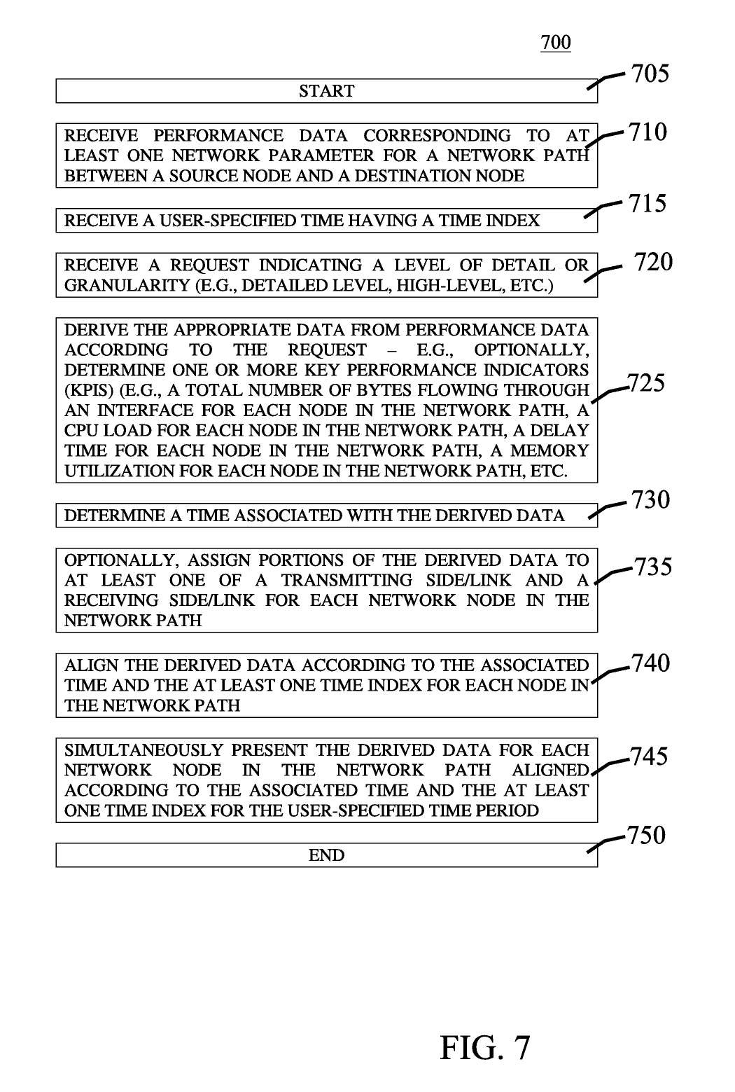

FIG. 7 illustrates an example simplified procedure 700 for visualizing performance data for nodes in a network path, particularly from the perspective of a network monitoring node. Procedure begins at step 705 and continues on to step 710 where, as discussed above, a network monitoring node receives receive performance data corresponding to at least one network parameter for a network path between a source node and a destination node. The network monitoring node also receives, in step 715, a user-specified time period having a time index.

Next, in step 720, the network monitoring node receives a request indicating a level of detail or granularity for the performance data. For example, as discussed above, a user can specify the particular level which the performance data is displayed—detailed and/or high-level performance data for each node, transmission link, receiving link, and the like. Optionally, the derived performance data can also include specific Key Performance Indicators (KPIs) corresponding to the requested level of detail. Such KPIs can include, for example, a total number of bytes flowing through an interface for each node in the network path, a CPU load for each node in the network path, a delay time for each node in the network path, a memory utilization for each node in the network path, and the like. In certain embodiments, discussed above, the network monitoring node derives high-level performance data, by averaging portions of the performance data assigned to the transmitting side/link and receiving side/link for each network node.

The network monitoring node further determines a time associated with the derived data in step 730, and in step 735, the network monitoring node can optionally assign portions of the derived data to a corresponding ingress/egress side (e.g., transmission side/link or receiving side/link) of the network nodes in the network path. In step 740, the derived data is aligned according to the associated time and the time index for each node in the network path and, in step 745, the derived data is simultaneously presented for each network node in the network path aligned according to the associated time and the time index for the user-specified period. In this fashion, the performance data—here, derived data—is displayed for each node in a network path aligned to the same axis, or the same time index.

Procedure 700 subsequently ends at step 750, but may begin again at step 710 where the network monitoring node receives performance data corresponding to network parameters for a network path.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for improved techniques displaying or visualizing network performance data for network paths to a user. In particular, the techniques herein significantly index performance data according to respective times as well as according to a user-specified time interval. In this fashion, a user can readily identify and troubleshoot network issues or network events that occur in various network paths.

The descriptions of the various embodiments of the present disclosure have been presented for purposes of illustration, but are not intended to be exhaustive or limited to the embodiments disclosed. For example, while the examples and embodiments discussed above refer to network performance data such as KPIs, such network parameters are not to be so limited. The network parameters can include any desirable network data for nodal systems (e.g., oil, traffic, electricity, etc.), as is appreciated by those skilled in the art. Further, many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for presenting network performance data, the method comprising:
receiving, by a network monitoring device, performance data corresponding to at least one network parameter for a network path between a source node and a destination node;
receiving, the network monitoring device, a user-specified time period having at least one time index;
determining, by the network monitoring device, a time associated with the performance data;
aligning, by the network monitoring device, the performance data according to the associated time and the at least one time index for each node in the network path; and
simultaneously presenting, by the network monitoring device, the performance data for each network node in the network path aligned according to the associated time and the at least one time index for the user-specified time period.

2. The method of claim 1, further comprising:
receiving, by the network monitoring device, a request for detailed performance data;
deriving, by the network monitoring device, the detailed performance data from the performance data, in response to the request,
wherein, determining a time associated with the performance data further comprises determining a time associated with the detailed performance data, in response to the request,
wherein, aligning the performance data further comprises aligning the detailed performance data according to the associated time and the at least one time index for each node in the network path, and
wherein, simultaneously presenting the performance data for each network node in the network path further comprises simultaneously presenting the detailed performance data for each network node in the network path aligned according to the associated time and the at least one time index for the user-specified time period, in response to the request.

3. The method of claim 1, further comprising:
receiving, by the network monitoring device, a request for high-level performance data;
deriving, by the network monitoring device, the high-level performance data from the performance data, in response to the request,
wherein, determining a time associated with the performance data further comprises determining a time associated with the high-level performance data, in response to the request,
wherein, aligning the performance data further comprises aligning the high-level performance data according to the associated time and the at least one time index for each node in the network path, and
wherein, simultaneously presenting the performance data for each network node in the network path further comprises simultaneously presenting the detailed performance data for each network node in the network path aligned according to the associated time and the at least one time index for the user-specified time period, in response to the request.

4. The method of claim 1, further comprising:
assigning, by the network monitoring device, portions of the performance data to at least one of a transmitting side and a receiving side for each network node in the network path, and
wherein, simultaneously presenting the performance data, further comprises simultaneously presenting the performance data for each network node in the network path aligned according to the associated time, the at least one time index for the user-specified time period, each transmitting side, and each receiving side for each node in the network path.

5. The method of claim 1, further comprising:
assigning, by the network monitoring device, portions of the performance data to at least one of a transmitting side and a receiving side for each network node in the network path; and
averaging, by the network monitoring device, the portions of the performance data assigned to the transmitting side and the receiving side for each network node in the network path to yield high-level performance data, and
wherein, simultaneously presenting the performance data, further comprises simultaneously presenting the high-level performance data for each network node in the network path aligned according to the associated time and the at least one time index for the user-specified time period.

6. The method of claim 1, further comprising:
determining, by the network monitoring device, one or more Key Performance Indicators (KPIs) from the performance data; and
wherein determining the time associated with the performance data further comprises determining a time associated with each KPI,
wherein aligning the performance data further comprises aligning each KPI according to the associated time and the at least one time index for each node in the network path, and
wherein simultaneously presenting the performance data, further comprises simultaneously presenting each KPI for each node in the network path aligned according to the associated time and the at least one time index for the user-specified time period.

7. The method of claim 6, wherein the one or more KPIs include at least two KPIs.

8. The method of claim 6, wherein the one or more KPIs include at least one of a total number of bytes flowing through an interface for each node in the network path, a CPU load for each node in the network path, a delay time for each node in the network path, and a memory utilization for each node in the network path.

9. A network monitoring device, comprising:
one or more network interfaces adapted to communicate in a communication network;
a processor adapted to execute one or more processes; and
a memory configured to store a process executable by the processor, the process when executed, is operable to:
receive performance data corresponding to at least one network parameter for a network path between a source node and a destination node;
receive a user-specified time period having at least one time index;
determine a time associated with the performance data;
align the performance data according to the associated time and the at least one time index for each node in the network path; and
simultaneously present the performance data for each network node in the network path aligned according to the associated time and the at least one time index for the user-specified time period.

10. The network monitoring device of claim 9, wherein the process, when executed by the processor, is further operable to:
assign portions of the performance data to at least one of a transmitting side and a receiving side for each network node in the network path, and
wherein, the process to simultaneously present the performance data, is further operable to simultaneously present the performance data for each network node in the network path aligned according to the associated time, the at least one time index for the user-specified time period, each transmitting side, and each receiving side for each node in the network path.

11. The network monitoring device of claim 9, wherein the process, when executed by the processor, is further operable to:
assign portions of the performance data to at least one of a transmitting side and a receiving side for each network node in the network path; and
average the portions of the performance data assigned to the transmitting side and a receiving side for each one network node in the network path to yield averaged performance data, and
wherein, the process to simultaneously present, is further operable simultaneously present the averaged performance data for each network node in the network path aligned according to the associated time and the at least one time index for the user-specified time period.

12. The network monitoring device of claim 9, wherein the process, when executed by the processor, is further operable to:
determine one or more Key Performance Indicators (KPIs) from the performance data,
wherein, the process to determine the time associated with the performance data, is further operable to determine a time associated with each KPI,
wherein the process to align the performance data, is further operable to align each KPI according to the associated time and the at least one time index for each node in the network path, and
wherein the process to simultaneously present the performance data, is further operable to simultaneously present each KPI for each node in the network path aligned according to the associated time and the at least one time index for the user-specified time period.

13. The network monitoring device of claim 12, wherein the one or more KPIs includes at least two KPIs.

14. The network monitoring device of claim 12, wherein the one or more KPIs include at least one of a total number of bytes flowing through an interface for each node in the network path, a CPU load for each node in the network path, a delay time for each node in the network path, and a memory utilization for each node in the network path.

15. A tangible, non-transitory, computer-readable media having software encoded thereon, the software, when executed by a hardware processor, is operable to:
receive performance data corresponding to at least one network parameter for a network path between a source node and a destination node;
receive a user-specified time period having at least one time index;
determine a time associated with the performance data;
align the performance data according to the associated time and the at least one time index for each node in the network path; and
simultaneously present the performance data for each network node in the network path aligned according to the associated time and the at least one time index for the user-specified time period.

16. The tangible, non-transitory, computer-readable media of claim 15, wherein the process, when executed by the hardware processor, is further operable to:
assign portions of the performance data to at least one of a transmitting side and a receiving side for each network node in the network path, and
wherein, the process to simultaneously present the performance data, is further operable to simultaneously present the performance data for each network node in the network path aligned according to the associated time, the at least one time index for the user-specified time period, each transmitting side, and each receiving side for each node in the network path.

17. The tangible, non-transitory, computer-readable media of claim 15, wherein the process, when executed by the hardware processor, is further operable to:
assign portions of the performance data to at least one of a transmitting side and a receiving side for each network node in the network path; and
average the portions of the performance data assigned to the transmitting side and a receiving side for each one network node in the network path to yield averaged performance data, and
wherein, the process to simultaneously present, is further operable simultaneously present the averaged performance data for each network node in the network path aligned according to the at least one time index for the user-specified time period.

18. The tangible, non-transitory, computer-readable media of claim 15, wherein the process, when executed by the hardware processor, is further operable to:
determine one or more Key Performance Indicators (KPIs) from the performance data,
wherein, the process to determine the time associated with the performance data, is further operable to determine a time associated with each KPI,
wherein the process to align the performance data, is further operable to align each KPI according to the associated time and the at least one time index for each node in the network path, and
wherein the process to simultaneously present the performance data, is further operable to simultaneously present each KPI for each node in the network path aligned according to the associated time and the at least one time index for the user-specified time period.

19. The tangible, non-transitory, computer-readable media of claim 18, wherein the one or more KPIs includes at least two KPIs.

20. The tangible, non-transitory, computer-readable media of claim 18, wherein the one or more KPIs include at least one of a total number of bytes flowing through an interface for each node in the network path, a CPU load for each node in the network path, a delay time for each node in the network path, and a memory utilization for each node in the network path.
